(19) United States
(12) Patent Application Publication
(10) Pub. No.: US 2009/0012435 A1
(43) Pub. Date: Jan. 8, 2009

(54) Adjustable massage tool

(76) Inventor: Curt Masek, Tallahassee, FL (US)

Correspondence Address: WILLIAM H. HOLLIMON, 215 SOUTH MONROE STREET, 2ND FLOOR, TALLAHASSEE, FL, 32301, US

(21) Appl. No.: 11/824,678

(22) Filed: Jul. 2, 2007

(51) Int. Cl. A61H 15/00

(52) U.S. Cl. 601/128

(57) ABSTRACT

An adjustable massage tool having a base and two adjustable “pressure balls” attached to the base. The base has a sloping face on both sides. The pressure balls are attached to threaded shanks. A pair of nuts are attached to the wooden base by shanks. The massage tool may be used to simultaneously provide pressure on any two pressure points on the user's back. The distance between the pressure balls (as well as the elevation of the pressure balls with respect to the base) may be adjusted by turning each threaded shank. To use the device the user simply rests his or her back on the pressure balls. The user preferably aligns the pressure balls on two “chi points” that are located on either side of the spinal column.

### BACKGROUND OF THE INVENTION

1. Field of the Invention

This invention relates to the field of massage tools. More specifically, the present invention comprises an adjustable massage tool configured to provide deep-penetrating pressure on a user's chi points.

2. Description of the Related Art

Various massage tools are known in the prior art for providing pressure on a user's muscles. Such massage tools come in many different configurations for different massage applications. Despite the existence of these massage devices, there remains a need for a massage tool capable of providing deep-penetrating pressure on “chi” points running along the length of a user's spine. It is further desirable for such a device to have adjustable pressure-applying features to accommodate the needs of various users.

### BRIEF SUMMARY OF THE INVENTION

The present invention comprises an adjustable massage tool having a base and two adjustable “pressure balls” attached to the base. The base has a sloping face on both sides. The pressure balls are attached to threaded shanks. A pair of nuts are attached to the wooden base by shanks. The massage tool may be used to provide pressure on two pressure points on the user's back. The distance between the pressure balls (as well as the elevation of the pressure balls with respect to the base) may be adjusted by turning each threaded shank. To use the device the user simply rests his or her back on the pressure balls. The user preferably aligns the pressure balls on two “chi points” that are located on either side of the spinal column.

### BRIEF DESCRIPTION OF THE SEVERAL VIEWS OF THE DRAWINGS

FIG. 1 is perspective view, showing the present invention.

FIG. 2 is a front view with ghosted lines, showing the present invention.

### REFERENCE NUMERALS IN THE DRAWINGS

| | | | |
|---|---|---|---|
| 10 | massage tool | 12 | pressure ball |
| 14 | base | 16 | nut |
| 18 | threaded shank | 20 | sloping face |
| 22 | shank | 24 | centerline projection |
| 26 | ground | | |

### DETAILED DESCRIPTION OF THE INVENTION

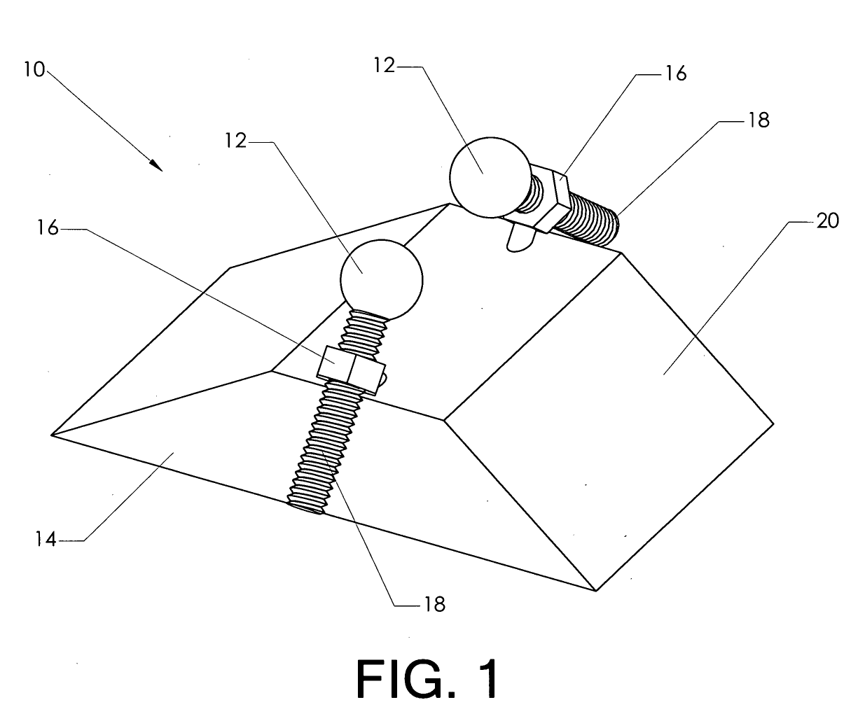

The present invention, massage tool 10 is illustrated in FIG. 1. Massage tool 10 includes base 14 and a pair of pressure balls 12. Pressure balls 12 are preferably approximately 1 inch in diameter and made of a hard material such as wood, plastic, or metal. Pressure balls 12 are adjustably attached to base 14 by the threaded engagement of threaded shanks 18 and nuts 16. This threaded attachment mechanism allows for the horizontal and vertical adjustment of pressure balls 12 as will be described in greater detail subsequently.

Base 14 has sloping face 20 on both ends so that the bottom of base 10 is larger than the top. This feature allows massage tool 10 to remain stable on the ground when the user reclines on top of massage tool 10. This feature also prevents the user's back from contacting any other part of massage tool 10 except for pressure balls 12 when lying on massage tool 10.

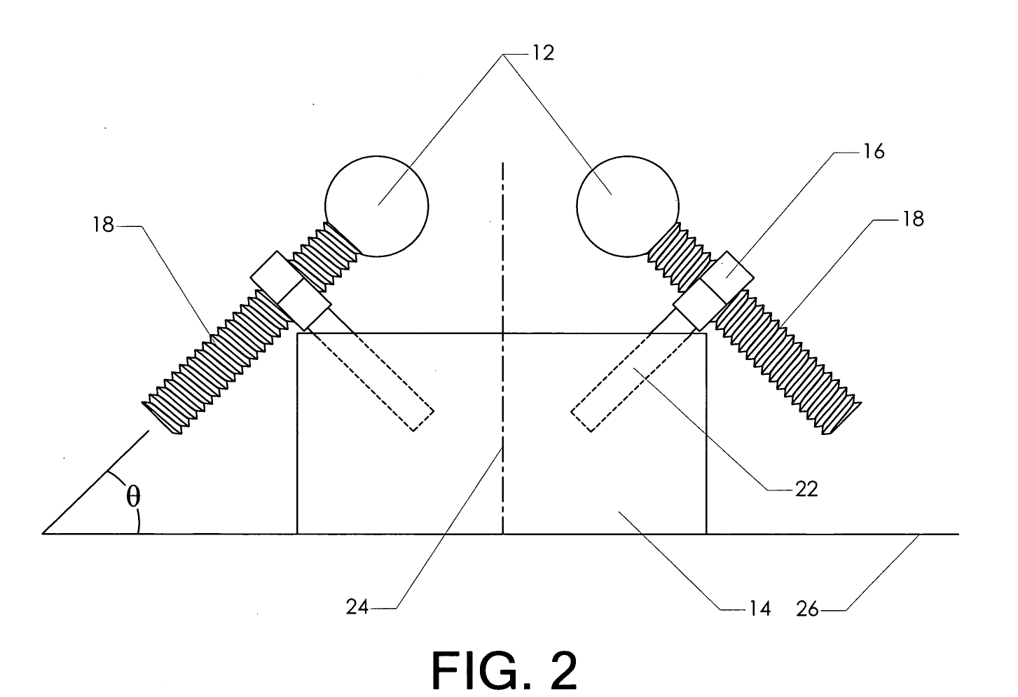

Turning now to FIG. 2, the reader will note that nuts 16 are attached to base 14 at such an angle that threaded shank 18 forms an angle θ with respect to ground 26 and the bottom of base 14. Angle θ is preferably in the range of 30 to 60 degrees, with a most preferred angle of approximately 45 degrees. This angle allows for the location of pressure balls 12 to be adjusted in the horizontal direction between centerline projection 24 and the side portions while simultaneously adjusting the vertical displacement of pressure balls 12 relative to the bottom of base 14. Thus, massage tool 10 may be adjusted to meet the needs of many different users.

Nuts 16 are attached to side portions of base 14 by shank 22. One end of shank 22 is welded or otherwise attached to nut 16 and the other end of shank 22 extends into base 14, thereby securing the two components together. Nuts 16 are preferably separated by a distance of 3 to 5 inches with a most preferred separation distance of approximately 4 inches. When attached in this manner, pressure balls 12 may be adjusted in the horizontal direction between the vertical projections of the sides of base 14 (where nuts 16 are attached) and centerline projection 24.

To use massage tool 10, the user first adjusts pressure balls 12 to the desired separation and vertical displacement. Experimentation may be required to identify the appropriate separation distance for the individual user. Generally, the distance between the centers of pressure balls 12 should be the same as the distance between the “chi” points on the user's back. These chi points may be found along both sides of the spinal column between the pelvis and the cranium. The separation distance may also be set to any distance that is comfortable and provides relief to the user's muscle pains. The user then places massage tool 10 on the ground as shown in FIG. 2. The user sits in front of massage tool 10 so that his or her back faces sloping face 20 and then reclines until pressure balls 12 are situated at the desired locations on the user's back. The user relaxes his or her muscles so that the user's body weight causes pressure balls 12 to supply deep-penetrating pressure into the sore muscles.

The preceding description contains significant detail regarding the novel aspects of the present invention. It should not be construed, however, as limiting the scope of the invention but rather as providing illustrations of the preferred embodiments of the invention. As an example, other adjustable attachment mechanisms may be used to attach pressure balls 12 to base 14. Thus, the scope of the invention should be fixed by the following claims, rather than by the examples given.

Having described my invention, I claim:

1. An adjustable massage tool comprising:
a. a base, said base having a first end, a second end, a bottom, a top, and a first side and a second side extending between said first end and said second end;
b. a first threaded fastener, said first threaded fastener attached to said base proximal said first side between said first end and said second end;
c. a second threaded fastener, said second threaded fastener attached to said base proximal said second side between said first end and said second end;
d. a first threaded shank, said first threaded shank having a first end and a second end, said first threaded shank configured to threadedly engage said first threaded fastener;
e. a first pressure ball, said first pressure ball attached to said first end of said first threaded shank;
f. a second threaded shank, said second threaded shank having a first end and a second end, said second threaded shank configured to threadedly engage said second threaded fastener; and
g. a second pressure ball, said second pressure ball attached to said first end of said second threaded shank;
h. wherein said first pressure ball and said second pressure ball are configured to extend upwards from said base when said bottom of said base is placed on the ground.

2. The adjustable massage tool of claim 1, wherein said first threaded fastener and said second threaded fastener are separated by a distance in the range of 3 to 5 inches.

3. The adjustable massage tool of claim 2, wherein said first threaded fastener and said second threaded fastener are separated by approximately 4 inches.

4. The adjustable massage tool of claim 1, wherein said first end of said base has a sloping face.

5. The adjustable massage tool of claim 1, wherein said first threaded shank is angled with respect to said bottom of said base by an angle in the range of 30 to 60 degrees.

6. The adjustable massage tool of claim 1, wherein said first threaded fastener is attached to said base by a shank, said shank having a first end and a second end, wherein said first end of said shank is attached to said first threaded fastener and said second end of said shank extends into said base.

7. An adjustable massage tool comprising:
a. a base, said base having a first end, a second end, a bottom, and a top; said base further comprising a first side portion and a second side portion extending between said first end and said second end; said base further comprising a centerline extending from said first end to said second end between said first side portion and second side portion;
b. a first pressure ball;
c. a first threaded attachment means for attaching said first pressure ball to said base; said first threaded attachment means configured to threadedly attach said first pressure ball to said first side portion of said base and allow for the horizontal adjustment of said first pressure ball between the vertical projections of said first side portion and said centerline;
d. a second pressure ball; and
e. a second threaded attachment means for attaching said second pressure ball to said base; said second threaded attachment means configured to threadedly attach said second pressure ball to said second side portion of said base and allow for the horizontal adjustment of said second pressure ball between the vertical projections of said second side portion and said centerline.

8. The adjustable massage tool of claim 7, wherein said first threaded attachment means and said second threaded attachment means are separated by a distance in the range of 3 to 5 inches.

9. The adjustable massage tool of claim 8, wherein said first threaded attachment means and said second threaded attachment means are separated by approximately 4 inches.

10. The adjustable massage tool of claim 7, wherein said first end of said base has a sloping face.

11. The adjustable massage tool of claim 7, wherein said first threaded attachment means is angled with respect to said bottom of said base by an angle in the range of 30 to 60 degrees.

12. The adjustable massage tool of claim 7, wherein said first threaded attachment means is attached to said base by a shank, said shank having a first end and a second end, wherein said first end of said shank is attached to said first threaded attachment means and said second end of said shank extends into said base.

13. An adjustable massage tool comprising:
a. a base said base having a first end, a second end, a bottom, and a top; said base further comprising a first side portion and a second side portion extending between said first end and said second end; said base further comprising a centerline extending from said first end to said second end between said first side portion and second side portion;
b. a first pressure ball;
c. a first adjustable attachment means for adjustably attaching said first pressure ball to said base; said first adjustable attachment means configured to adjustably attach said first pressure ball to said first side portion of said base; said first adjustable attachment means configured to adjust the horizontal position of said first pressure ball between the vertical projections of said first side portion and said centerline while simultaneously adjusting the vertical position of said first pressure ball relative to the bottom of said base;
d. a second pressure ball; and
e. a second adjustable attachment means for adjustably attaching said second pressure ball to said base; said second adjustable attachment means configured to adjustably attach said second pressure ball to said second side portion of said base; said second adjustable attachment means configured to adjust the horizontal position of said second pressure ball between the vertical projections of said second side portion and said centerline while simultaneously adjusting the vertical position of said second pressure ball relative to the bottom of said base.

14. The adjustable massage tool of claim 13, wherein said first adjustable attachment means and said second adjustable attachment means are separated by a distance in the range of 3 to 5 inches.

15. The adjustable massage tool of claim 14, wherein said first adjustable attachment means and said second adjustable attachment means are separated by approximately 4 inches.

16. The adjustable massage tool of claim 13, wherein said first end of said base has a sloping face.

17. The adjustable massage tool of claim 13, wherein said first adjustable attachment means is angled with respect to said bottom of said base by an angle in the range of 30 to 60 degrees.

18. The adjustable massage tool of claim 7, wherein said first adjustable attachment means is attached to said base by a shank, said shank having a first end and a second end, wherein said first end of said shank is attached to said first adjustable attachment means and said second end of said shank extends into said base.
